(19) United States
(12) Patent Application Publication
(10) Pub. No.: US 2014/0354774 A1
(43) Pub. Date: Dec. 4, 2014

(54) IMAGE PROCESSING DEVICE, IMAGE PROCESSING METHOD, STEREOSCOPIC IMAGE DISPLAY DEVICE, AND ASSISTANT SYSTEM

(71) Applicant: KABUSHIKI KAISHA TOSHIBA, Tokyo (JP)

(72) Inventor: Yoshiyuki Kokojima, Yokohama-shi (JP)

(73) Assignee: KABUSHIKI KAISHA TOSHIBA, Tokyo (JP)

(21) Appl. No.: 14/177,567

(22) Filed: Feb. 11, 2014

(30) Foreign Application Priority Data
May 31, 2013 (JP) 2013-116191

(51) Int. Cl. H04N 13/02; G06T 15/00

(52) U.S. Cl. CPC H04N 13/0246; G06T 15/00; H04N 13/0207
USPC 348/45; 348/49

(57) ABSTRACT

According to an embodiment, an image processing device is connected to an observation device to observe an object optically. The image processing device includes an acquirer and a generator. The acquirer is configured to acquire a volume data including frames of section image data of the object and information indicating the focal position of the observation device. The generator is configured to perform rendering of the volume data from a plurality of viewpoints to generate a stereoscopic image in such a way that a region of attention in the stereoscopic image has an amount of parallax equal to or smaller than a predetermined threshold value, where the region of attention corresponds to the focal position of the observation device.

### CROSS-REFERENCE TO RELATED APPLICATIONS

This application is based upon and claims the benefit of priority from Japanese Patent Application No. 2013-116191, filed on May 31, 2013; the entire contents of which are incorporated herein by reference.

### FIELD

Embodiments described herein relate generally to an image processing device, an image processing method, a stereoscopic image display device, and an assistant system.

### BACKGROUND

Typically, in the field of medical diagnostic imaging devices such as X-ray computer tomography (CT) scanners, magnetic resonance imaging (MRI) scanners, or ultrasound diagnostic devices; devices capable of generating three-dimensional medical images (volume data) have been put to practical use. Moreover, a technology for rendering the volume data from arbitrary viewpoints has also been put into practice. Furthermore, a technology is known in which parallax images are generated by means of rendering of the volume data from a plurality of viewpoints, and are displayed in a stereoscopic manner in a stereoscopic image display device.

In such a stereoscopic image display device, there are times when a stereoscopic image pops out toward the near side of the display or recedes toward the far side of the display. As a result, there occurs a decline in the degree of definition of the stereoscopic image thereby causing slurring or blurring of the stereoscopic image. Thus, in order to stereoscopically display the volume data in an effective manner, it is important that a position of attention, to which the user should pay attention, is placed at such a depth position at which the volume data is displayed at the highest degree of definition without any occurrence of popping out toward the near side or receding toward the far side.

As a conventional technology to serve that purpose, an interface called a boundary box is known. The boundary box represents such a region in the virtual space of computer graphics (CG) in which a stereoscopic image reproduced in a stereoscopic image display device has the degree of definition equal to or greater than a permissible value. At the cross-sectional plane at the center (at a focal plane) of the boundary box, the amount of parallax of an object to be displayed becomes equal to zero. That is, the object is displayed at the highest degree of definition without any occurrence of popping out toward the near side or receding toward the far side. If the user moves the boundary box and matches the focal plane to the position of attention, then that position of attention can be displayed at the highest degree of definition.

In recent years, regarding microscopically-controlled surgeries (microsurgeries) in which the surgical instruments are operated while looking at them through a microscope, consideration is being given to a configuration in which the abovementioned stereoscopic image display device is installed along with the microscope with the aim of stereoscopically displaying the volume data generated by a medical diagnostic imaging device, such as a CT device or an MRI device, and presenting the surgeon (doctor) with the information about the inside of the body that is not directly viewable using the microscope.

However, when the surgeon looks away from the microscope and views the stereoscopic display device, many a time the portion that was being viewed by focusing the microscope is not in focus for stereoscopic images. Herein, it is assumed. that “focus for stereoscopic images” means the degree of blurring of stereoscopic images; and it is assumed that “be in focus for stereoscopic images” represents a condition in which the focal plane of the boundary box is placed at the desired position, and the desired position is displayed at the highest degree of definition. As a result, every time a stereoscopic image is viewed, the surgeon (or the surgical assistant) needs to adjust the focus for stereoscopic images to the same focus of the microscope. That causes a decline in the efficiency while performing the operation.

### BRIEF DESCRIPTION OF THE DRAWINGS

FIG. 1 is a diagram illustrating a configuration example of an image display system according to an embodiment;

FIG. 2 is a diagram for explaining an example of volume data according to the embodiment;

FIG. 3 is a diagram illustrating a configuration example of a stereoscopic image display device according to the embodiment;

FIG, 4 is a schematic diagram illustrating a display according to the embodiment;

FIG. 5 is a schematic diagram illustrating a display according to the embodiment;

FIG. 6 is conceptual diagram illustrating a case in which the volume data according to the embodiment is displayed in a stereoscopic manner;

FIG. 7 it is a diagram illustrating a configuration of an image processing unit according to the embodiment;

FIG. 8 is a schematic diagram for explaining the settings performed by a first setter according to the embodiment;

FIG. 9 is a schematic diagram for explaining the settings performed by a first setter according to the embodiment;

FIG. 10 is a schematic diagram for explaining the settings performed by a second setter according to the embodiment;

FIG. 11 is a schematic diagram for explaining the settings performed by a second setter according to the embodiment;

FIGS. 12A and 12B are conceptual diagrams each illustrating a case of rendering the volume data according to the embodiment;

FIG. 13 is a flowchart illustrating an example of the operations performed in the stereoscopic image display device according to the embodiment; and

FIG. 14 is a diagram illustrating a configuration example of an image processing unit according to a modification example.

### DETAILED DESCRIPTION

According to an embodiment, an image processing device is connected to an observation device to observe an object optically. The device includes an acquirer and a generator. The acquirer is configured to acquire a volume data including frames of section image data of the object and information indicating the focal position of the observation device. The generator is configured to perform rendering of the volume data from a plurality of viewpoints to generate a stereoscopic image in such a way that a region of attention in the stereoscopic image has an amount of parallax equal to or smaller than a predetermined threshold value, where the region of attention corresponds to the focal position of the observation device.

Embodiment is described below in detail with reference to the accompanying drawings.

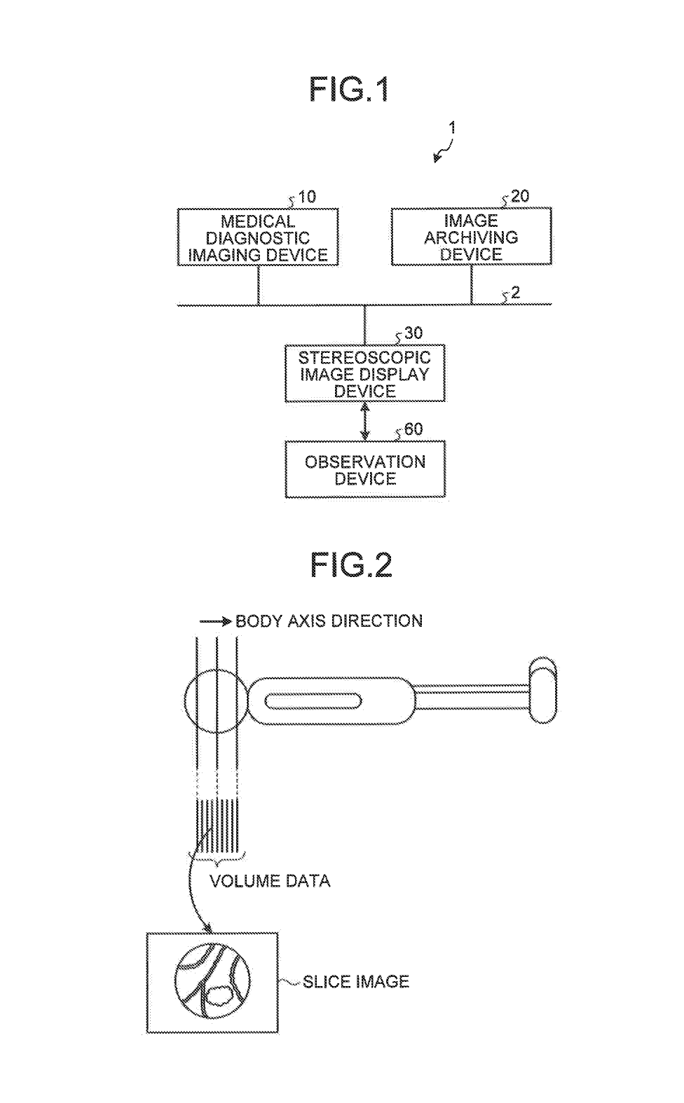

FIG. 1 is a block diagram illustrating a configuration example of an image display system 1 according to the embodiment. As illustrated in FIG. 1, the image display system 1 includes a medical diagnostic imaging device 10, an image archiving device 20, a stereoscopic image display device 30, and an observation device 60.

In the example illustrated in FIG. 1, the medical diagnostic imaging device 10, the image archiving device 20, and the stereoscopic image display device 30 are communicable to each other directly or indirectly via a communication network 2 and are capable of sending medical images to each other and receiving medical images from each other. The communication network 2 can be of any arbitrary type. For example, the configuration can be such that the medical diagnostic imaging device 10, the image archiving device 20, and the stereoscopic image display device 30 are mutually communicable via a local region network (LAN) installed in a hospital. Alternatively, for example, the configuration can be such that the medical diagnostic imaging device 10, the image archiving device 20, and the stereoscopic image display device 30 are mutually communicable via a network (cloud) such as the Internet.

Moreover, the stereoscopic image display device 30 and the observation device 60 are connected to each other in a communicable manner. Meanwhile, any arbitrary type of connection configuration can be adopted between the stereoscopic image display device 30 and the observation device 50. That is, the stereoscopic image display device 30 and the observation device 60 can be connected using a wired connection or using a wireless connection.

In the image display system 1, stereoscopic images are generated from volume data of three-dimensional medical image data, which is generated by the medical diagnostic imaging device 10. Then, the stereoscopic images are displayed on a display with the aim of providing stereoscopically viewable medical images to doctors or laboratory personnel working in the hospital. Herein, stereoscopic images point to images that enable an observer to perform stereoscopic viewing. As an example, according to the embodiment, a stereoscopic image includes a plurality of parallax images having mutually different parallaxes. The explanation of each device is given below in order.

The medical diagnostic imaging device 10 is capable of generating three-dimensional medical image data (volume data). As the medical diagnostic imaging device 10; it is possible to use, for example, an X-ray diagnostic apparatus, an X-ray computer tomography (CT) device, a magnetic resonance imaging (MRI) device, an ultrasound diagnostic device, a single photon emission computer tomography (SPECT) device, a positron emission computed tomography (PET) device, a SPECT-CT device configured by integrating a SPECT device and an X-ray CT device, a PET-CT device configured by integrating a PET device and an. X-ray CT device, or a group of these devices.

The medical diagnostic imaging device 10 captures images of a subject being tested, to thereby generate volume data. For example, the medical diagnostic imaging device 10 captures images of a subject being tested; collects data such as projection data or MR signals; reconfigures a plurality of (for example, 300 to 500) slice images (cross-sectional images) along the body axis direction of the subject being tested; and generates volume data. Thus, as illustrated in FIG. 2 a plurality of slice images, which is taken along the body axis direction of the subject being tested, represents the volume data. In the following explanation, the direction corresponding to the body axis direction of the subject being tested is sometimes referred to as “volume data depth direction”. In the example illustrated in FIG. 2, the volume data of the brain of the subject being tested is generated. Meanwhile, the projection data or the MR signals of the subject being tested, which is captured by the medical diagnostic imaging device 10, can itself be considered as the volume data.

The image archiving device 20 is a database for archiving medical images. More particularly, the image archiving device 20 is used to store and archive the volume data and position information sent by the medical diagnostic imaging device 10.

The stereoscopic image display device 30 displays stereoscopic images each of which includes a plurality of parallax images having mutually different parallaxes. The stereoscopic image display device 30 can be configured to implement the integral imaging method (II method) or the 3D display method in the multi-eye mode. Examples of the stereoscopic image display device 30 include a television (TV) or a personal computer (PC) that enables viewers to view stereoscopic images with the unaided eye. In the embodiment, the stereoscopic image display device 30 generates stereoscopic images using the volume data acquired from the image archiving device 20, and displays the stereoscopic images.

The observation device 60 that is connected to the stereoscopic image display device 30 is a device to observe an object optically. In the embodiment, the observation device 60 is configured. with a microscope (an operation microscope). Since a microscope has an extremely shallow depth of field (i.e., has an extremely narrow focal range), the surgeon (doctor) performs a microscopically-controlled surgery by accurately focusing on the position of attention (such as the tip position of a surgical instrument).

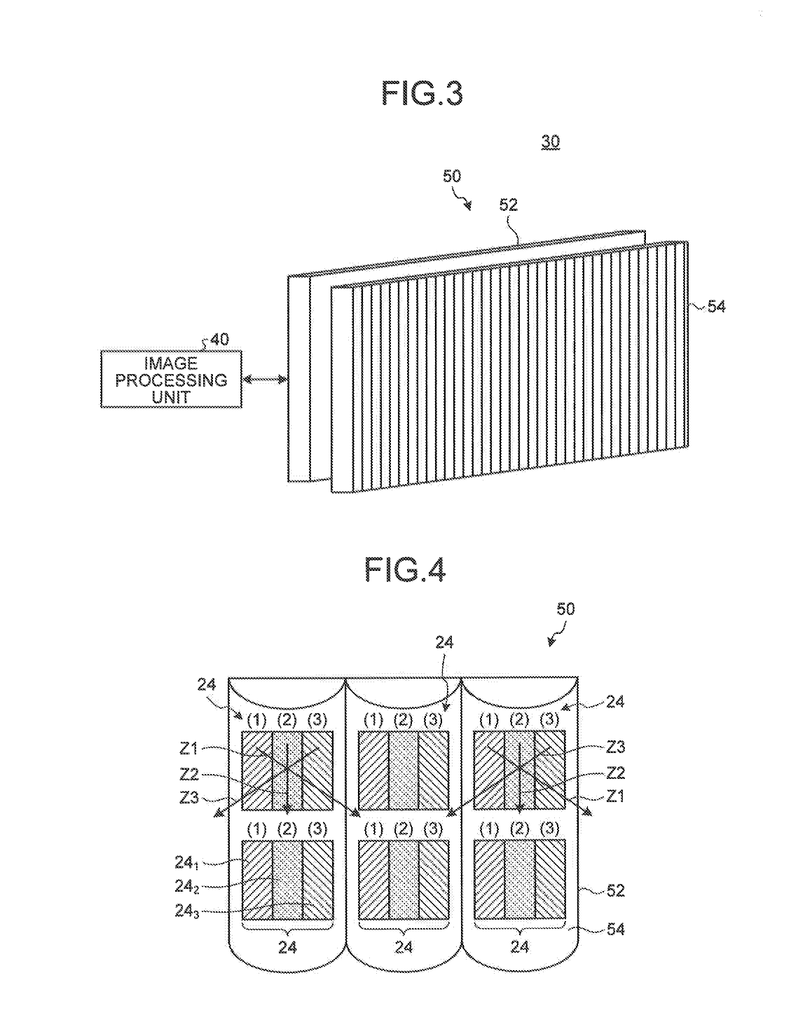

Given below is the explanation of a specific configuration of the stereoscopic image display device 30. FIG. 3 in a diagram illustrating a configuration example of the stereoscopic image display device 30. As illustrated in FIG. 3, the stereoscopic image display device 30 includes an image processing unit 40 and a display 50. For example, the image processing unit 40 and the display 50 can be connected via a communication network (network). The image processing unit 40 generates stereoscopic images using the volume data that is acquired from the image archiving device 20. The detailed description of that operation is given later.

The display 50 displays thereon the stereoscopic images generated by the image processing unit 40. As illustrated in FIG. 3, the display 50 includes a display panel 52 and a light beam control unit 54. The display panel 52 is a liquid crystal panel in which a plurality of sub-pixels having different color components (such as red (R), green (G), and blue (B) colors) are arranged in a matrix-like manner in a first-direction (for example, the row direction (the left-right direction) with reference to FIG. 3) and a second direction (for example, the column direction (the vertical direction) with reference to FIG. 3). In this case, a single pixel is made of RGB sub-pixels arranged in the first direction, Moreover, an image that is displayed on a group of pixels, which are adjacent pixels equal in number to the number of parallaxes and which are arranged in the first direction, is called a member image. Thus, the display 50 displays a stereoscopic image in which a plurality of member images is arranged in a matrix-like manner. Meanwhile, any other known arrangement of sub-pixels can be adopted in the display 50. Moreover, the sub-pixels are not limited to the three colors of red (R), green (G), and blue (B). Alternatively, for example, the sub-pixels can also have four colors.

As the display panel 52, it is possible to use a direct-view-type two-dimensional display such as an organic electro luminescence (organic EL), a liquid crystal display (LCD), a plasma display panel (PDP), or a projection-type display. Moreover, the display panel 52 can also have a configuration including a backlight.

The light beam control unit 54 is disposed opposite to the display panel 52 with a clearance gap maintained therebetween. The light beam control unit 54 controls the direction of emission of the light beam that is emitted from each sub-pixel of the display panel 52. The light beam control unit 54 has a plurality of linearly-extending optical apertures arranged in the first direction for emitting light beams. For example, the light beam control unit 54 can be a lenticular sheet having a plurality of cylindrical lenses arranged thereon or can be a parallax barrier having a plurality of slits arranged thereon. The optical apertures are arranged corresponding to the member images of the display panel 52.

In the embodiment, in the stereoscopic image display device 30, the sub-pixels of each color component are arranged in the second direction, while the color components are repeatedly arranged in the first direction thereby forming a “longitudinal stripe arrangement”. However, that is not the only possible case. Moreover, in the first embodiment, the light beam control unit 54 is disposed in such a way that the extending direction of the optical apertures thereof is consistent with the second direction of, the display panel 52. However, that is not the only possible case. Alternatively, for example, the configuration can be such that the light beam control unit 54 is disposed. in, such a way that the extending direction of the optical apertures thereof has a predetermined tilt with respect to the second direction of the display panel 52.

FIG. 4 is a schematic diagram illustrating some portion of the display 50 in an enlarged manner. In FIG. 4, identification information of parallax images is represented as parallax numbers (1) to (3). Thus, herein, parallax numbers that are uniquely assigned to parallax images represent the identification information of the parallax images. Hence, the pixels corresponding to the same parallax number display the same parallax image. In the example illustrated in FIG. 4, a member image 24 is created by arranging the pixels of each of the parallax images that are identified by the parallax numbers (1) to (3) in that sequence. Herein, although the explanation is given for an example in which there are three parallaxes (corresponding to parallax numbers 1 to 3) , it is not the only possible case. Alternatively, any other number of parallaxes can be used (for example, nine parallaxes corresponding to parallax numbers 1 to 9).

As illustrated in FIG. 4, in the display panel 52, the member images 24 are arranged in a matrix-like manner in the first direction and the second direction. For example, when the number of parallaxes is equal to three, each member image 24 is a group of pixels in which a pixel 24₁ of a parallax image 1, a pixel 242 of a parallax image 2, and a pixel 24₃ of a parallax image 3 are sequentially arranged in the first direction.

In each member image 24, the light beam emitted from the pixels (the pixel 24₁ to the pixel 24₃) of the parallax images reaches the light beam control unit 54. Then, the light beam control unit 54 controls the travelling direction and the scattering of each light beam, and shoots the light beams toward the whole plane of the display 50. For example, in each member image 24, the light emitted from the pixel 24₁ of the parallax image 1 travels in the direction of an arrow Z1; the light emitted from the pixel 24₂ of the parallax image 2 travels in the direction of an arrow Z2; and the light emitted from the pixel 24₃ of the parallax image 3 travels in the direction of an arrow Z3. In this way, in the display 50, the direction of emission of the light emitted from each pixel in each member image is regulated by the light beam control unit 54.

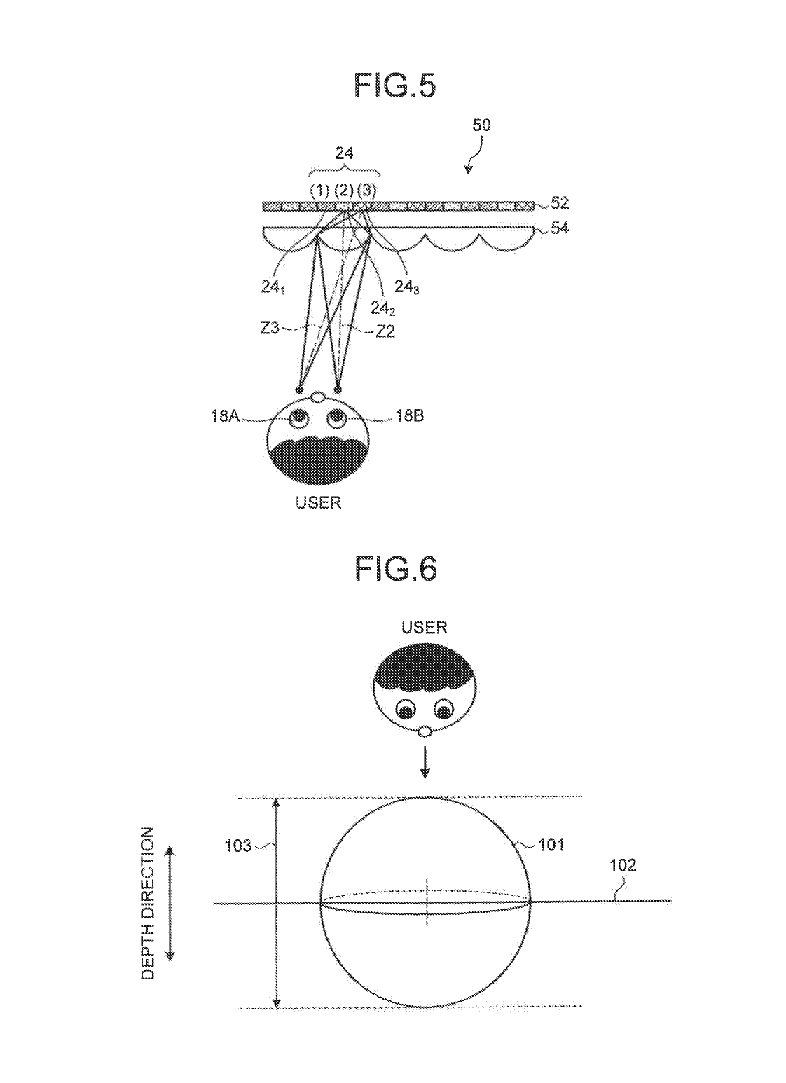

FIG. 5 is a schematic diagram illustrating a situation in which a user (viewer) is viewing the display 50. When a stereoscopic image made of a plurality of member images 24 is displayed on the display panel 52, the pixels of the parallax images included in the member images 24 and viewed by the user with a left eye 18A are different than the pixels of the parallax images included in the member images 24 and viewed by the user with a right eye 18B. In this way, when images having different parallaxes are displayed with respect to the left eye 18A and the right eye 18B of the user, it becomes possible for the user to view stereoscopic images.

FIG. 6 is conceptual diagram illustrating a case in which the volume data of the brain illustrated in FIG. 2 is displayed in a stereoscopic manner. In FIG. 6, a stereoscopic image of the volume data 101 of the brain is a conceptually illustrated. Moreover, in FIG. 6, a focal plane 102 represents the focal plane of the display 50. The focal plane points to a plane that, during stereoscopic viewing, does not pop out toward the near side or does not recede toward the far side. Longer the distance from the focal plane, sparser becomes the density of light beams emitted from the pixels of the display panel 52. Hence, the resolution of images also goes on deteriorating. In that regard, with the aim of displaying the entire volume data of the brain at a high degree of definition, it is necessary to take into account a stereoscopic display allowable range 103 (corresponding to a focal range described later) that indicates the range in the depth direction within which the display 50 can display stereoscopic images at a high degree of definition equal to or greater than a permissible value (i.e., indicates a display boundary). That is, as illustrated in FIG. 6, various parameters (such as the camera intervals, angles, and positions at the time of creating stereoscopic images) need to be set in such a way that, during stereoscopic display, the entire volume data 101 of the brain falls within the stereoscopic display allowable range 103. Herein, the stereoscopic display allowable range 103 is a parameter determined depending on the specifications or the standards of the display 50, and can be stored in a memory (not illustrated) that is installed in the stereoscopic image display device 30 or can be stored in an external device.

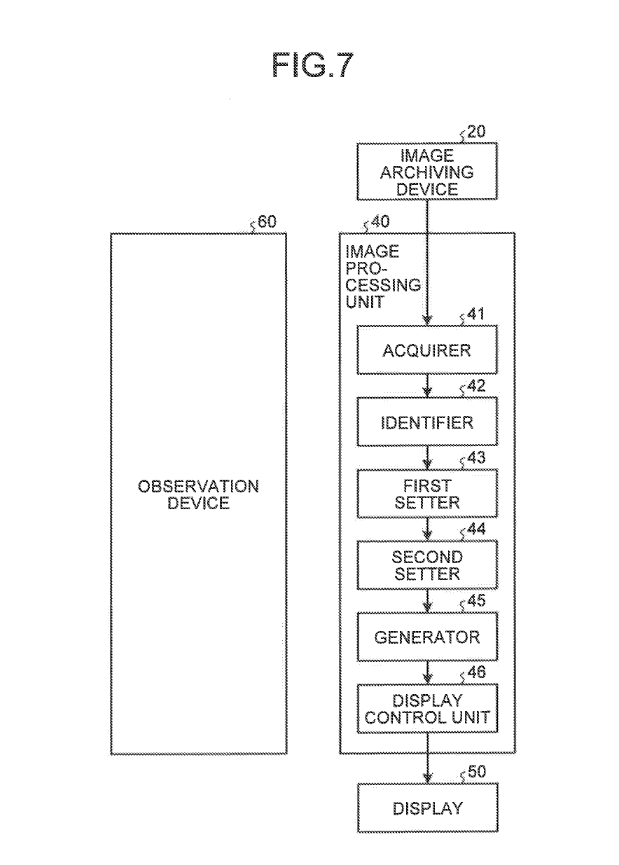

Given below is the detailed explanation of the image processing unit 40. FIG. 7 is a block diagram illustrating a configuration of the image processing unit 40. As illustrated in FIG. 7, the image processing unit 40 includes an acquirer 41, an identifier 42, a first setter 43, a second setter 44, a generator 45, and a display control unit 46. Moreover, the image processing unit 40 is connected to the observation device 60. Meanwhile, the in processing unit 40 corresponds to an “image processing device” mentioned in the claims.

The acquirer 41 acquires a volume data including of section image data of the object (for example, a brain) and information indicating the focal position of the observation device 60. The specifics are explained as follows. The acquirer 41 accesses the image archiving device 20 and acquires the volume data generated by the medical diagnostic imaging device 10. The volume data may contain position information that enables identification of the positions of internal organs such as bones, blood vessels, nerves, tumors, and the like. Such position information can be managed in any arbitrary format. For example, identification information, which enables identification of the types of internal organs, and voxel groups, which constitute the internal organs, can be managed in a corresponding manner. Alternatively, to each voxel included in the volume data, it is possible to append identification information that enables identification of the type of the internal organ to which that voxel belongs. Meanwhile, the volume data may also include information related to the coloration and opacity at the time of rendering of each internal organ.

Moreover, in addition to the volume data, the acquirer 41 also acquires, from the observation device 60, such data from the volume data which enables identification of a region of attention that indicates a region (can be only a point) corresponding to the focal position of the observation device 60 (in the following explanation, the data is sometimes referred to as “focal data”). The focal data can contain, for example, the focal length, the aperture, the f-ratio, and. the depth of field of the lens of the observation device 60. Alternatively, the focal data can represent, for example, the coordinate value indicating the focal position of the observation device 60 in the coordinate system of the observation device 60. In the embodiment, the explanation is given for an example in which the acquirer 41 acquires, as the focal data, the coordinate value that indicates the focal position of the observation device 60 in the coordinate system of the observation device 60. Meanwhile, the acquirer 41 can acquire the focal data at an arbitrary timing. In the embodiment, every time the focal position (focus) of the observation device 60 is changed due to the operation of a surgeon (or an assistant), the observation device 60 sends the focal data of that timing to the acquirer 41.

The identifier 42 identifies the region of attention based on the information indicating the focal position of the observation device 60. More particularly, the identifier 42 identifies the region of attention based on the focal data acquired by the acquirer 41. In the embodiment, the identifier 42 transforms the coordinate value that is indicated by the focal data acquired by the acquirer 41 (i.e., transforms the coordinate value in the coordinate system of the observation device 60) into the coordinate value in the coordinate system of the volume data. Then, as the region of attention, the identifier 42 identifies the region that is indicated by the post-conversion coordinate value in the volume data.

The first setter 43 sets the position of the boundary box in such a way that, in a virtual space for the rendering of the volume data, the focal plane, which indicates the plane having the highest degree of definition from among the boundary box that represents the region in which stereoscopic images are displayed at the degree of definition equal to or greater than a permissible value, includes the region of attention. Herein, at the central cross-sectional plane of the boundary box, the amount of parallax of the object to be displayed becomes equal to zero. That is, at the central cross-sectional plane of the boundary box, the object to be displayed gets displayed at the highest degree of definition without any occurrence of popping out toward the near side or receding toward the far side. In this description, this cross-sectional plane is called “focal plane”. For example, in the virtual space, if the boundary box is moved (i.e., if the position of the boundary box in the virtual space is set) in such a way that the focal plane matches with the region of attention such as a region of lesion from among the volume data; then that region of attention can be displayed at the highest degree of definition. Herein, the degree of definition (resolution) mentioned in this description points to the density of light beams. Thus, the degree of definition of a stereoscopic image points to the density of the light be that are emitted from the pixels of the display panel 52. Moreover, the boundary box mentioned in this description is based on the same concept as the boundary box disclosed in Japanese Patent Application Laid-open No 2007-96951.

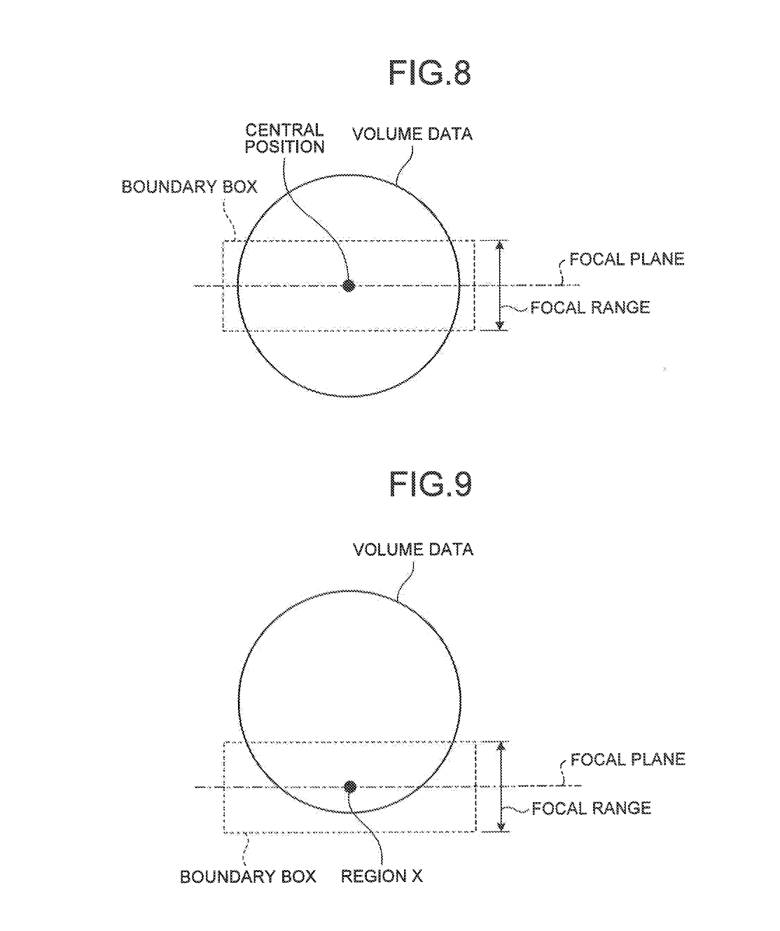

In the embodiment, in a default configuration in which the region of attention is not identified, the position of the boundary box in the virtual space is set in such a way that the focal plane includes the center (center of gravity) of the volume data as illustrated in FIG. 8. On the other hand, consider a case in which the region of attention is identified by the identifier 42 and the region of attention represented in the coordinate system of the volume data corresponds to a region X of the volume data in the virtual space. In that case, as illustrated in FIG. 9, the first setter 43 sets the position of the boundary box in the virtual space in such a way that the focal plane includes the region X (the region of attention).

Returning to the explanation with reference to FIG. 7; the second setter 44 sets the region of the boundary box in a variable manner in the depth direction (the front-back direction). Herein, the plane on the near side of the boundary box represents a pop out display boundary, while the plane on the far side of the boundary box represents a receding display boundary. Both those planes correspond to the positions at which the degree of definition of a stereoscopic image decreases to a predetermined permissible value (for example, when the degree of definition of the focal plane is 100%, the permissible value can be set to be the value corresponding to 50% of the degree of definition). In this description, the region between those two planes, that is, the region in the depth direction (the front-back direction) of the boundary box is called “focal range”. If the focal range is varied (i.e., if the thickness of the boundary box is widened or shortened), it becomes possible to specify such a region in the vicinity of the focal plane up to which stereoscopic display can be performed at the degree of definition equal to or greater than the permissible value.

In the embodiment, depending on the depth of field of the observation device 60, the second setter 44 sets in a variable manner the range in the depth direction of the boundary box. More particularly, the second setter 44 sets the focal range in tune with the depth of field that is specified in the focal data acquired by the acquirer 41. That is, the second setter 44 sets the range in the depth direction of the boundary box (focal range) at a region corresponding to the depth of field of the observation device 60 so as to match the boundary box, among the volume data in the virtual space.

Moreover, the second setter 44 sets the range in the depth direction of the boundary box in such a way that a region of the volume data having a predetermined degree of definition for stereoscopic images corresponds to the region that indicates a value corresponding to the abovementioned predetermined degree of definition for medical images from among the medical images presented by the observation device 60. An example of that is explained below.

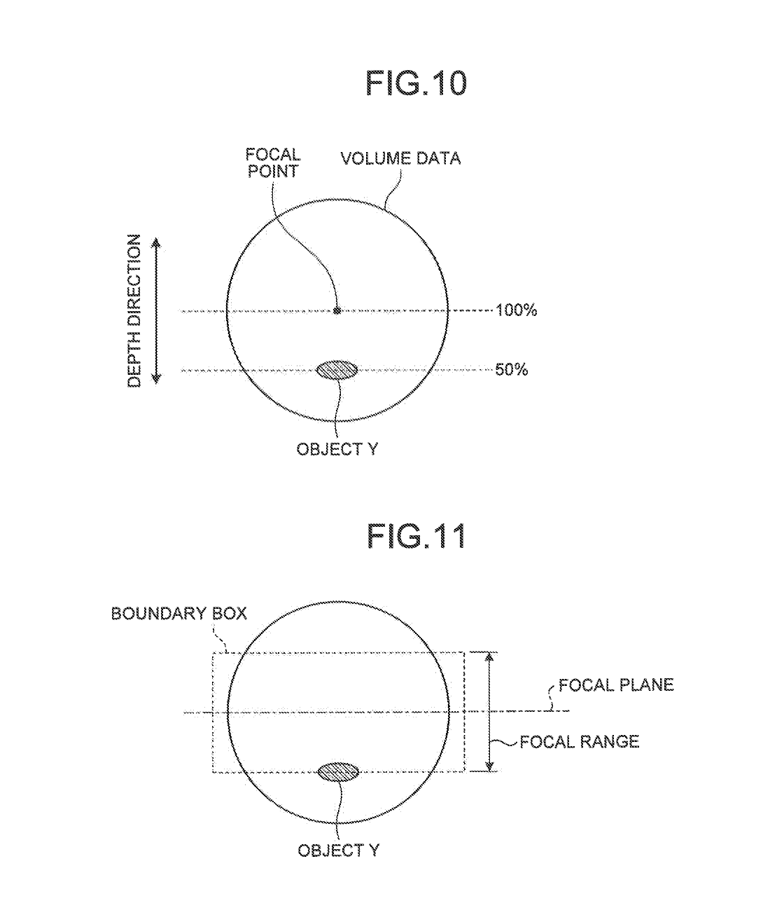

FIG. 10 is a schematic diagram illustrating a relationship between the position in the depth direction (the front-back direction) of the region of attention of the volume data and the degree of definition of medical images in the case when medical images that are in focus of the observation device 60 are considered to have the degree of definition of 100%. In this example, since the observation device 60 is a microscope, it is possible to think that the degree of definition of medical images points to the degree of convergence of the light from the lens (i.e., the density of light beams). In the example illustrated in FIG. 10, from among the medical images presented by the observation device 60 (the microscope), it can be regarded that an object Y appears in the near-side region having the degree of definition of 50%.

In this example, it is assumed that the plane representing the pop out display boundary on the near side of the boundary box has the degree of definition of 50%; and it is assumed that 50% degree of definition of stereoscopic images corresponds to 50% degree of definition of medical images. Accordingly, the second setter 44 sets the region in the depth direction of the boundary box in such a way that the internal region of the boundary box having 50% degree of definition (for stereoscopic images) (i.e., the plane representing the pop out display boundary on the near side of the boundary box) corresponds to a near-side region in the medical images presented by the observation device 60 that have the degree of definition of 50%. That is, as illustrated in FIG. 11, the second setter 44 sets the focal range in such a way that, in the virtual space, the plane representing the pop out display boundary on the near side of the boundary box includes the object Y. As a result, it becomes possible to match the range in which the medical images presented by the observation device 60 are in focus with a range in which the stereoscopic images are in focus.

However, that is not the only possible case. Alternatively, for example, the second setter 44 can set the range (region) in the depth direction of the boundary box to a predetermined value (a fixed value) according to the specifications of the display 50. Still alternatively, for example, the second setter 44 can set the range in the depth direction of the boundary box in a variable manner according to a user instruction.

Returning to the explanation with reference to FIG. 7, the generator 45 performs rendering of the volume data from a plurality of viewpoints to generate a stereoscopic image in such a way that the region of attention in the stereoscopic image has an amount of parallax equal to or smaller than a predetermined threshold value. Herein, the predetermined threshold value can be set to an arbitrary value. In the embodiment, as an example, the threshold value is set to zero. More particularly, based on the boundary box for which the first setter 43 has set the position and the second setter 44 has set the focal range, the generator 45 calculates a plurality of viewpoint positions (i.e., positions at which virtual cameras are placed corresponding to a multiple view image that is to be created). From the calculated viewpoint positions, the generator 45 then performs rendering of the volume data acquired by the acquirer 41, to thereby generate a plurality of parallax images (i.e., generates a stereoscopic image). In rendering the volume data, various volume rendering techniques that are already known can be used.

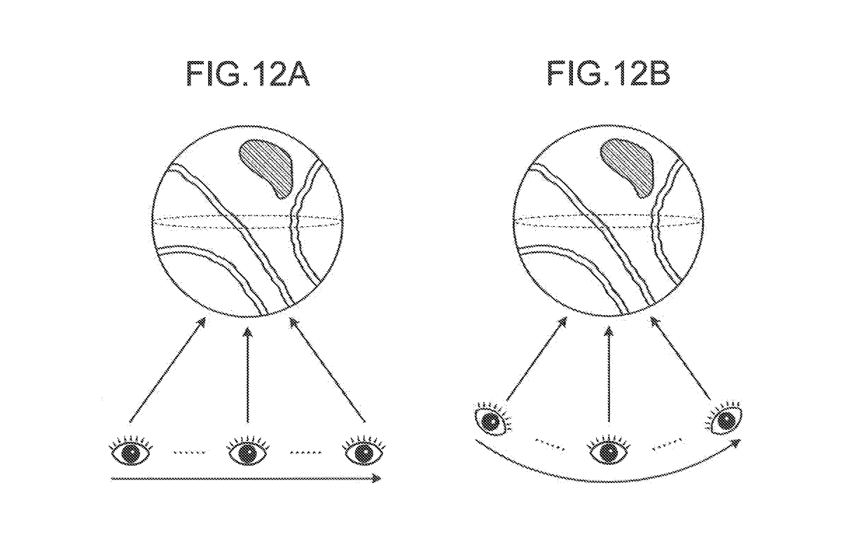

FIGS. 12A and 12B are conceptual diagrams each illustrating a case of rendering the volume data from a plurality of viewpoints. In FIG. 12A is illustrated an example in which a plurality of viewpoints is linearly arranged at regular intervals. In FIG. 12B is illustrated an example in which a plurality of viewpoints is arranged in a rotational manner. Meanwhile, the projection method implemented in performing volume rendering can either be parallel projection or be perspective projection. Alternatively, it is also possible to perform projection combining parallel projection and perspective projection.

Returning to the explanation with reference to FIG. 7, the display control unit 46 performs control to display the stereoscopic image, which is generated by the generator 45 and which includes a plurality of parallax images, on the display 50.

Meanwhile, in the embodiment, the image processing unit 40 has a hardware configuration that includes a central processing unit (CPU), a read only memory (ROM), a random access memory (RAM), and a communication interface I/F device. The functions of the abovementioned constituent elements (i.e., the acquirer 41, the identifier 42, the first setter 43, the second setter 44, the generator 45, and the display control unit 46) are implemented when the CPU loads computer programs, which are stored in the ROM, in the RAM and runs them. However, that is not the only possible case. Alternatively, at least some of the functions of the constituent elements can be implemented using a dedicated hardware circuit (such as a semiconductor integrated circuit.

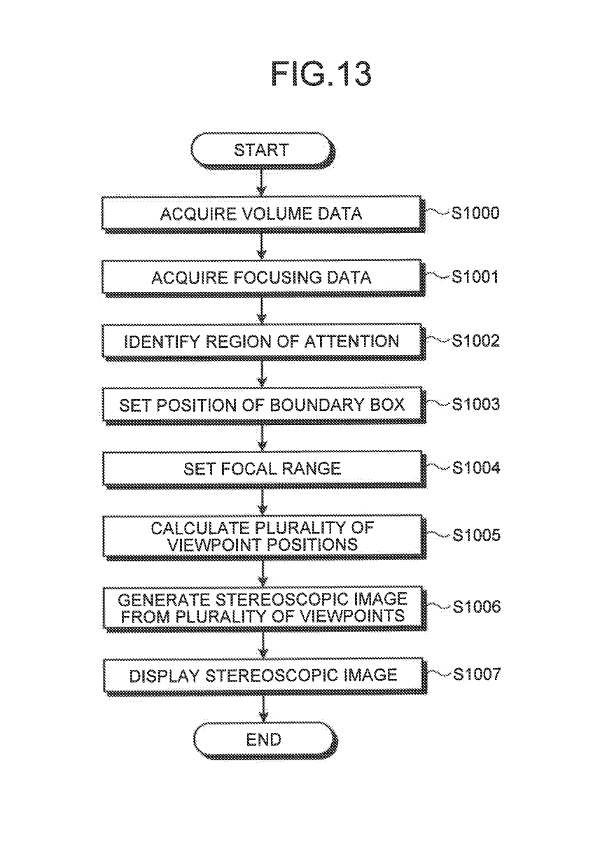

Given below is the explanation of an example of the operations performed in the stereoscopic image display device 30 according to the embodiment. FIG. 13 is a flowchart illustrating an example of the operations performed in the stereoscopic image display device 30. Firstly, the acquirer 41 accesses the image archiving device 20 and acquires the volume data generated by the medical diagnostic imaging device 10 (Step S1000). Then, the acquirer 41 acquires the focal data from the observation device 60 (Step S1001). Subsequently, based on the focal data acquired at Step S1001, the identifier 42 identifies the region of attention (Step S1002). Then, the first setter 43 sets, in the virtual space, the position of the boundary box in such a way that the focal plane of the boundary box includes the region of attention (Step S1003). Subsequently, the second setter 44 sets the focal range in tune with the depth of field that is specified in the focal data acquired at Step S1001 (Step S1004). Then, based on the boundary box for which the position is set at Step S1003 and the focal range is set at Step S1004, the generator 45 calculates a plurality of viewpoint positions (Step S1005). Subsequently, the generator 45 performs rendering of the volume data, which is acquired at Step S1000, from a plurality of viewpoint positions calculated at Step S1005, to thereby generate a plurality of parallax images (Step S1006). Then, the display control unit 46 performs control to display a stereoscopic image, which includes the parallax images generated at Step S1006, on the display 50 (Step S1007).

As described above, in the embodiment, every time the surgeon who is performing a microscopically-controlled operation changes the focal position of the operation microscope (which is an example of the observation device 60); the image processing unit 40 acquires, from the volume data, focal data that enables identification of the region of attention which indicates a region corresponding to the focal position of the operation microscope (i.e., the position in focus); and generates a stereoscopic image from the volume data in such a way that the amount of parallax of the region of attention is equal to or smaller than a threshold value (i.e., in such a way that the region. of attention is displayed at the highest degree of definition). Hence, when the surgeon who has changed the focal position of the microscope looks away from the microscope and views the display 50, it becomes possible for the surgeon to view a stereoscopic image that is focused to the position which was being viewed till then by the surgeon by focusing through the microscope. That is, according to the embodiment, every time the focal position of the microscope is adjusted, the surgeon (or the assistant) need not match the focus of the stereoscopic image to the focus of the microscope. That enables achieving enhancement in the efficiency of the operation.

### Modifications

Given below is the explanation of modifications. It is possible to arbitrarily combine the modifications described below. Moreover, it is possible to arbitrarily combine the modifications described below and the embodiment described above.

### First Modification

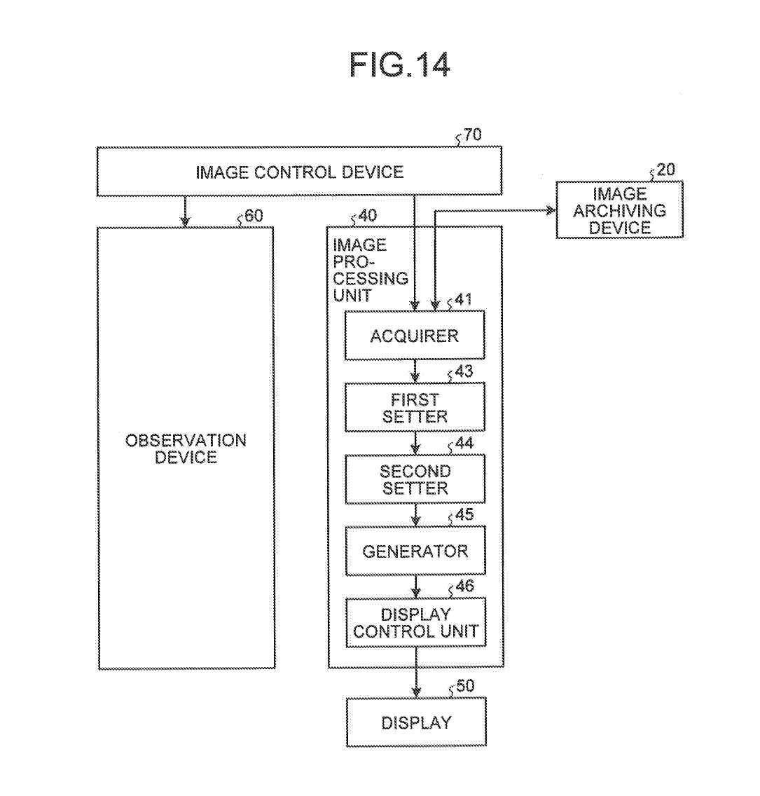

In the embodiment, the image processing unit 40 (the acquirer 41) acquires the focal data from the observation device 60 that includes an optical system. However, that is not the only possible case. Alternatively, for example, as illustrated in FIG. 14, the acquirer 41 can acquire the focal data from an image control device 70 that detects the tip position of a surgical instrument on real-time basis and informs the surgeon of the tip position. In essence, as long as the acquirer 41 acquires the focal data from an external device such as the observation device 60 or the image control device 70, it serves the purpose.

As far as the surgical operations of recent years are concerned, an operation navigation system has been but into practice for detecting the tip position of a surgical instrument on a real-time basis and informing the surgeon of the tip position. In many instances, the tip position of a surgical instrument matches with the region of attention of the object that the surgeon wishes to view by focusing the microscope (i.e., the observation device 60). The image control device 70 has the function of adopting, for example, the operation navigation system in order to detect the tip position of a surgical instrument and send position information to an external device.

In the example illustrated in FIG. 14, every time the tip position of a surgical instrument is detected, the image control device 70 sends, as the focal data to the image processing unit 40 (the acquirer 41), the coordinate value corresponding to its detected tip position of the surgical instrument in the coordinate system or the volume data; and sends, as information specifying the focal position of the microscope (as focal position specification information) to the observation device 60, the coordinate value corresponding to the detected tip position of the surgical instrument in the coordinate system of the microscope. Then, as the region of attention, the coordinate value indicated by the focal data acquired from the image control device 70 can be identified as it is to be the region of attention by the acquirer 41. That is, in the example illustrated in FIG. 14, the identifier 42 becomes redundant. In other words, the image control device 70 may be considered to control the stereoscopic image display device 30 such that the stereoscopic image is remade when the image control device 70 detects a change in the focal position of the observation device 60. Furthermore, the image control device 70 may perform, when the image control device 70 detects a change in the region. of attention in the stereoscopic image, a control to accordingly change the focal position of the observation device 60. In this example, the image control device 70 may be considered to correspond to the “controlling device” recited in the claims.

Meanwhile, in the example illustrated in FIG. 14, the observation device 60 can be configured to have the function of automatically shifting the focal position according to the focal position specification information that is acquired from the image control device 70. In this example, the image control device 70 may correspond to the “controlling device” recited in the claims.

Moreover, for example, the configuration can be such that, every time the tip position of a surgical instrument is detected, the image control device 70 sends, as the focal data to the acquirer 41, the coordinate value corresponding to the detected tip position of the surgical instrument in the coordinate system of the image control device 70. In this configuration, the image processing unit 40 needs to identify the region of attention by converting the coordinate system of the focal data. Hence, in an identical manner to the embodiment described above, the image processing unit 40 includes the identifier 42, which transforms the coordinate value indicated by the focal data that is acquired by the acquirer 41 (i.e., transforms the coordinate value in the coordinate system of the image control device 70) into a coordinate value in the coordinate system of the volume data. Then, the identifier 42 identifies the region indicated by the post-conversion coordinate value in the volume data as the region of attention.

### Second Modification

In the embodiment described. above, every time the focal position of the observation device 60 is changed due to the operation of a surgeon (or an assistant), the observation device 60 sends, as the focal data to the image processing unit 40 (the acquirer 41), the coordinate value indicating the focal position therein the coordinate system thereof. However, that is not the only possible case. Alternatively, for example, the observation device 60 can send, as the focal data to the image processing unit 40 (the acquirer 41), the coordinate value indicating the focal position therein the coordinate system of the volume data. In such a configuration, the coordinate value indicated by the focal data acquired from the observation device 60 can be identified as it is to be the region of attention by the image processing unit 40. That is, in an identical to the example illustrated in FIG. 14, the identifier 42 becomes redundant. In essence, the image processing unit 40 can be configured to have the function of acquiring the data (the focal data) that enables identification of the region of attention which indicates a region corresponding to the focal position of the observation device 60.

### Third Modification

In the embodiment described above, a microscope (an operation microscope) is given as an example of the observation device 60 having an optical system. However, that is not the only possible case. Alternatively, for example, an endoscope can also be used as the observation device 60.

### Fourth Modification

In the embodiment described above, the image processing unit 40 (the generator 45) performs rendering of the volume data, which is acquired by the acquirer 41, from each calculated viewpoint and generates a plurality of parallax images. However, that is not the only possible case. Alternatively, for example, instead of generating a plurality of parallax images, the image processing unit 40 can directly generate a stereoscopic image from the volume data. For example, from among a plurality of sub-pixels arranged in the display panel 52, for each group of one or more sub-pixels that are regarded to emit light beams in the same direction, the image processing unit 40 can calculate representative light beam information indicating the direction of light beams emitted from that group; calculate the brightness value of each group from the representative light beam information of that group and from the volume data; and generate a stereoscopic image. Regarding the method of calculating the brightness values, it is possible to use ray casting or ray tracing that are widely known methods in the field of computer graphics. Ray casting points to the method in which the light beams are tracked from a predetermined viewpoint and rendering is performed by integrating color information at the points of intersection between the light beams and an object. Ray tracing points to a method in which the reflected light is also taken into account while implementing ray casting.

### Computer Programs

Meanwhile, the computer programs executed in the image processing unit 40 can be saved as downloadable files on a computer connected to the Internet or can be made available for distribution through a network such as the Internet. Alternatively, the computer programs executed in the image processing unit 40 can be stored in advance in a nonvolatile memory medium such as a ROM.

While certain embodiments have been described, these embodiments have been presented. by way of example only, and are not intended to limit the scope of the inventions. Indeed, the novel embodiment described herein may be embodied in a variety of other forms; furthermore, various omissions, substitutions and changes in the form of the embodiment described herein may he made without departing from the spirit of the inventions. The accompanying claims and their equivalents are intended to cover such forms or modifications as would fall within the scope and spirit of the inventions.

What is claimed is:

1. An image processing device that is connected to an observation device to observe an object optically comprising:
an acquirer configured to acquire a volume data including frames of section image data of the object, and information indicating the focal position of the observation device; and
a generator configured to perform rendering of the volume data from a plurality of viewpoints to generate a stereoscopic image in such a way that a region of attention in the stereoscopic image has an amount of parallax equal to or smaller than a predetermined threshold value, the region of attention corresponding to the focal position of the observation device.

2. The device according to claim 1, further comprising a first setter configured to, in a virtual space for the rendering of the volume data, set a position of a boundary box, which represents a region in which the stereoscopic image is displayed at a degree of definition equal to or greater than a permissible value, in such a way that a focal plane, which is a plane of the boundary box having the highest degree of definition, includes the region of attention, wherein
the generator calculates positions of the plurality of viewpoints based on the boundary box.

3. The device according to claim 2, further comprising a second setter configured to, depending on a depth of field of the observation device, set a range in a depth direction of the boundary box in a variable manner.

4. The device according to claim 3, wherein the second setter sets the range in the depth direction of the boundary box at a region corresponding to the depth of field of the observation device so as to match the boundary box, among the volume data.

5. The device according to claim 1, wherein the acquirer acquires the information indicating the focal position from the observation device.

6. The device according to claim 5, further comprising an identifier configured to identify the region of attention based on the information acquired by the acquirer.

7. The device according to claim 1, wherein the acquirer acquires the information indicating the focal position of the observation device from an image control device that detects a tip position of a surgical instrument on a real-time basis and informs a surgeon of the tip position.

8. The device according to claim 7, wherein the acquirer acquires, from the image control device, the information indicating a region in the volume data corresponding to the tip position of the surgical instrument, and identifies the region indicated by the acquired information as the region of attention.

9. The device according to claim 1, wherein the observation device is a microscope or an endoscope.

10. The device according to claim 1, wherein
The acquirer and the generator are implemented as a processor.

11. An image processing method comprising:
obtaining the volume data; and
performing rendering of the volume data in such a way that, from among the volume data, a region of attention, which corresponds to a focal position of a observation device that is connected to the image processing device and that includes an optical system, has an amount of parallax equal to or smaller than a predetermined threshold value, to thereby generate the stereoscopic image.

12. A stereoscopic image display device that is connected to an observation device to observe an object optically comprising:
an acquirer configured to acquire a volume data including frames of section image data of the object, and information indicating the focal position of the observation device;
a generator configured to perform rendering of the volume data from a plurality of viewpoints to generate a stereoscopic image in such a way that a region of attention in the stereoscopic image has an amount of parallax equal to or smaller than a predetermined threshold value, the region of attention corresponding to the focal position of the observation device; and
a display configured to display the stereoscopic image.

13. An assistant system comprising:
a controlling device;
a stereoscopic image display device that generates a stereoscopic image in accordance with control performed by the controlling device; and
an observation device that observes an object optically in accordance with control performed by the controlling device, wherein the controlling device controls the stereoscopic image display device and the observation device in such a way that a region of attention in the stereoscopic image has an amount of parallax equal to or smaller than a specific threshold value, the region of attention corresponding to a focal position of the observation device

14. The system according to claim 13, wherein the observation device is a microscope or an endoscope.

15. The system according to claim 13, wherein the controlling device controls the stereoscopic image display device such that the stereoscopic image is remade when a change in the focal position of the observation device is detected.

16. The system according to claim 13, wherein the controlling device performs, when a change in the region of attention in the stereoscopic image is detected, a control to accordingly change the focal position of the observation device.
